(19) United States
(12) Patent Application Publication
(10) Pub. No.: US 2003/0162571 A1
(43) Pub. Date: Aug. 28, 2003

(54) Mobile phone accessory for providing multi-chord ring tones

(76) Inventor: Je-Hwan Chung, Seoul (KR)

Correspondence Address: Douglas A. Mullen, Dickinson Wright PLLC, Suite 800, 1901 L. Street NW, Washington, DC, 20036, US

(21) Appl. No.: 10/137,213

(22) Filed: May 2, 2002

(30) Foreign Application Priority Data
Feb. 26, 2002 (KR) 10-2002-0010183

(51) Int. Cl. H04M 1/00

(52) U.S. Cl. 455/567; 455/550; 455/90

(57) ABSTRACT

Disclosed herein is a mobile phone accessory for providing multi-chord ring tones. The mobile phone accessory has a reception sensor unit, a control unit, a sound source unit and a reproducing unit. The reception sensor unit senses a reception operation generated when receiving a call in a vibration mode of the mobile phone, converts sensed information into a call reception signal, and transmits the call reception signal to a control unit. The control unit reads a music file corresponding to a ring tone previously selected by a user through a selection unit from a storage unit which stores music files, and transmits the read music file when the control unit receives the call reception signal. The sound source unit receives the selected music file from the storage unit through the control unit, outputs the received music file as a multi-chord ring tone, and transmits the multi-chord ring tone. The reproducing unit reproduces multi-chord ring tone output information of the music file received from the sound source unit.

### BACKGROUND OF THE INVENTION

The present invention relates generally to a mobile phone accessory for providing multi-chord ring tones, and more particularly to a mobile phone accessory, which is attached to a mobile phone not supporting multi-chord ring tones so as to provide multi-chord ring tones.

Mobile phones recently marketed are classified into four kinds, such as monotone melody mobile phones, 4-chord melody mobile phones, 16-chord melody mobile phones and 32-chord melody mobile phones.

First, the monotone melody mobile phone can output only a single-tone sound. That is, the monotone melody phone can express only a buzzer sound. Since the monotone melody phone is not equipped with a chip for reproducing sound source files, it cannot download 4-chord, 16-chord and 32-chord ring tones even though it is upgraded.

Further, the 4-chord melody mobile phone can simultaneously output 4 tones differently from the monotone melody mobile phone, and has a sound source chip therein to represent various instrumental sounds such as the sounds of a piano, a guitar, etc. The 4-chord melody mobile phone is so-called an orchestra mobile phone. As described above, such a mobile phone has a sound source chip, that is, a sound chip, such that it can express ring tones thereof using a maximum of four instrumental sounds. In this case, only a 4-chord melody-only mobile phone can use 4-chord ring tones. Ring tones basically stored in the 4-chord melody-only mobile phone can include a train sound, a cuckoo sound and a wave sound, as well as basic melodies. The 4-chord melody mobile phone can be also provided with a monotone melody service.

The 16-chord melody mobile phone can simultaneously output 16 tones, by overcoming the limit of only outputting 4-chord sounds, and is so-called a multi-chord melody mobile phone. That is, the 16-chord melody mobile phone is advantageous in that a drum sound, a human voice and a natural sound, which cannot be expressed by the 4-chord melody mobile phone, can be expressed as ring tones by the 16-chord melody mobile phone, so richer sounds can be expressed as the ring tones. The 16-chord melody mobile phone is classified into two kinds according to sound source chips: a CMX phone having a so-called CMX sound source chip, and a ma2 phone having a so-called ma2 sound source chip. For example, a 16-chord melody phone of Nokia includes the CMX chip, and most 16-chord melody phones except for the Nokia phone include ma2 chips to be marketed. Like in the case that a user purchases a sound card when buying a computer, the CMX or ma2 is regarded as a kind of sound card.

The 32-chord melody mobile phone extended from the 16-chord melody mobile phone is advantageous in that it can simultaneously output more tones than those of the conventional 16-chord melody mobile phone. A ma3 phone having a so-called ma3 sound source chip is a 32-chord melody mobile phone introduced to the Korean market.

Neither the monotone nor 4-chord melody mobile phones can provide a multi-chord ring tone function for supporting multi-chord ring tones approximating a natural sound, while they are inexpensive compared with the multi-chord melody mobile phones. On the other hand, the multi-chord melody (16-chord and 32-chord) mobile phones having a function of providing multi-chord ring tones are advantageous in that they can express natural sounds as ring tones, while there has been raised a problem that they are too expensive for general consumers to purchase.

Further, it is impossible to upgrade only ring tones of the conventional monotone melody mobile phone or the 4-chord melody mobile phone to multi-chord ring tones. Accordingly, there has been also raised a problem that a user must newly purchase an expensive mobile phone for supporting multi-chord ring tones if the user desires multi-chord ring tones.

Meanwhile, with the commercialization and large-scale popularization of mobile phones, various accessories attached to the mobile phones are produced. However, such an accessory only performs a function of providing simple ornamental or decorative effect to mobile phones. Therefore, there has been proposed a request for a useful accessory capable of performing various functions.

Further, for conventional 16-chord and 32-chord melody mobile phones, the user must personally download new ring tones by calling special melody download service companies such as 700 service providers or accessing a corresponding Web site using a wireless application protocol (WAP) so as to use new ring tones except for basic ring tones stored in the mobile phones. However, these methods are problematic in that the costs of the services are too high, download speeds thereof are too slow, and the amounts of transmitted music files and the sizes thereof are limited due to a problem relating to packet sizes (for example, a music file is limited in its size to 20 KB per a melody).

Further, the conventional mobile phones are problematic in that it is difficult to install a sufficient memory within each mobile phone due to trend of miniaturization, multi-function and increased number of parts of mobile phones, such that music files having a sufficient number of melodies cannot be stored or downloaded.

### SUMMARY OF THE INVENTION

Accordingly, the present invention has been made keeping in mind the above problems occurring in the prior art, and an object of the present invention is to provide a mobile phone accessory, which is attached to a multi-chord melody mobile phone, which does not satisfy a user's desire for sound quality or is limited in the size of a music file storage space, as well as a conventional monotone mobile phone, which does not support multi-chord ring tones, so as to provide multi-chord ring tones, thereby eliminating a problem of additionally purchasing an expensive multi-chord melody mobile phone only for multi-chord ring tones.

Another object of the present invention is to provide a mobile phone accessory, which provides a multi-chord ring tone supporting function together with a conventional accessory function for decoration of a mobile phone.

A further object of the present invention is to provide a mobile phone accessory, which allows a user to directly download desired ring tone melodies from his personal computer so as to provide a prompt, optional and economical ring tone download service.

In order to accomplish the above object, the present invention provides a mobile phone accessory for providing multi-chord ring tones, comprising a reception sensor unit for sensing a reception operation generated when receiving a call in a vibration mode of the mobile phone, converting sensed information into a call reception signal, and transmitting the call reception signal to a control unit; a control unit for reading a music file corresponding to a ring tone previously selected by a user through a selection unit from a storage unit which stores music files, and transmitting the read music file when the control unit receives the call reception signal; a sound source unit for receiving the selected music file from the storage unit through the control unit, outputting the received music file as a multi-chord ring tone, and transmitting the multi-chord ring tone; and a reproducing unit for reproducing multi-chord ring tone output information of the music file received from the sound source unit.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a mobile phone accessory for providing multi-chord ring tones according to a preferred embodiment of the present invention; and

FIG. 2 is a perspective view showing an example of the connection of the mobile phone accessory for providing multi-chord ring tones to a mobile phone.

### DESCRIPTION OF THE PREFERRED EMBODIMENTS

Hereinafter, embodiments of the present invention will be described in detail with reference to the attached drawings.

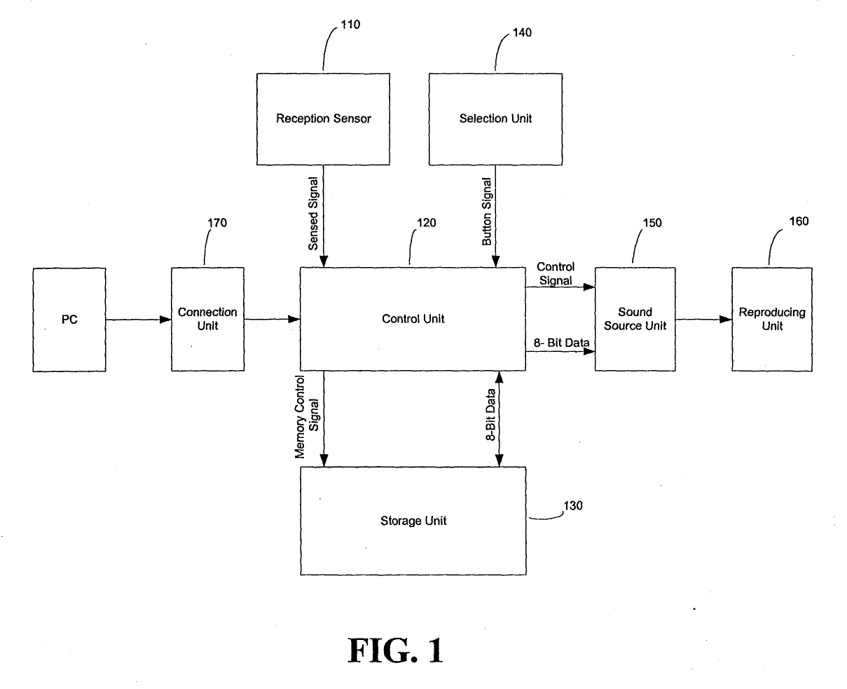

FIG. 1 is a block diagram of a mobile phone accessory having a function of providing multi-chord ring tones according to the present invention. Referring to FIG. 1, the mobile phone accessory of this invention comprises a reception sensor unit 110, a control unit 120, a storage unit 130, a selection unit 140, a sound source unit 150, and a reproducing unit 160. The mobile phone accessory of this invention further comprises a connection unit 170.

The reception sensor unit 110 performs functions of sensing by its vibration operation that the mobile phone enters a reception mode by a phone call from the outside, and transmitting call reception information to the control unit 120. Preferably, the reception sensor unit 110 can be realized as a vibration sensor.

In order to utilize the mobile phone accessory of the present invention, ring tones are provided by the accessory of this invention, therefore the mobile phone must be set to a vibration mode so as not to output ring tones therefrom.

The reception sensor unit 110 realized as a vibration sensor performs a function of transmitting a call reception signal to the control unit 120 to inform the control unit 120 of the reception of call. Here, the call reception signal is obtained by converting a waveform of a vibration generated from the mobile phone, which senses the reception of call and generates the vibration by a phone call from the outside, into an electrical signal.

The control unit 120 performs the function of controlling the reception sensor unit 110, the storage unit 130, the selection unit 140 and the sound source unit 150.

The control unit 120 receives the call reception signal from the reception sensor unit 110, reads music files corresponding to ring tones, which are previously selected through the selection unit 140 by the user, from the storage unit 130, and sends the music files to the sound source unit 150.

The control unit 120 is constructed to function to download music files to the storage unit 130 from the personal computer (PC) through the connection with the PC using a serial port communication, a universal serial bus (USB) communication and an infrared ray communication, and to allow the downloaded music files to be stored. Further, the control unit 120 performs the function of deleting or registering desired melodies of the music files stored in the storage unit 130 according to the selection of the selection unit 140.

For downloading and storing of music files, the connection unit 170 connects the PC with the control unit 120. Therefore, the connection unit 170 manages the accessory to download music files, which are previously downloaded to the PC and stored in the PC using various methods, to the storage unit 130 of the mobile phone accessory of the present invention by the user paying a predetermined fee (for example, credit card payment, mobile phone payment, mileage, and cash payment) to a corresponding Internet Web site. The connection unit 170 may include a serial port cable, a USB cable, and an infrared communication port (IrDA). Preferably, the serial port cable serves as the connection unit 170.

The control unit 120 includes a logic circuit for control operation. A microcontroller or a programmable logic device (PLD), that is, an IC by which required logic functions can be directly formed and used by a user serves as the control unit 120. Preferably, the microcontroller is employed as the control unit 120 in consideration of universalization and scalability.

The storage unit 130 performs a function of storing music files to be provided to the sound source unit 150. The storage unit 130 is preferably implemented as a memory for storing music files, such as a random access memory (RAM). The music files are typically stored as 8 bit data as shown in FIG. 1. Methods of storing music files in the memory are classified into two kinds: a method of previously storing ring tones when a memory is manufactured, and a method of downloading music files from the PC through the connection unit 170 under the control of the control unit 120. Further, the storage unit 130 can be preferably constructed to store ring tones of 10 to 20 melodies according to the capacity of the memory. Further, the storage unit 130 can be also constructed to delete some melodies if the capacity of memory is exceeded or an undesirable melody is stored. Each music file stored as 8 bit data must have a format readable by the sound source unit 150. For example, if the sound source unit 150 employs ML series of Oki company as a sound source chip, standard MIDI files as standard music files, GM MIDI files and PCM/ADPCM sounds are stored in the format of DMX data which are data of a sound source code of Oki company.

The second method of storing music files is not limited in the size of music files, because the download method is not a conventional WAP packet transmission method but a Web to Machine method of directly downloading music files from the PC. Further, the storage unit 130 is an additional device, not a part installed within the mobile phone, such that its storage space can be freely expanded. For example, the storage space is set to 2 MB, so a sufficient number of melodies can be stored in the storage unit 130.

The selection unit 140 performs a function of selecting a melody corresponding to a desired ring tone. The selection unit 140 can be implemented as a button which is projected from the surface of the accessory to have a predetermined height. The button can be operated such that each melody stored in the storage unit 130 is reproduced to the user, while changing melodies whenever a user presses the button, similar to a typical method of selecting ring tones in a conventional mobile phone. At this time, when finding a desired melody, the user presses a selection button to select the desired melody. Melody selection information by the selection unit 140 is transmitted to the control unit 120. The control unit 120 registers the selected melody of the music files stored in the storage unit 130 as a ring tone. The selection unit 140 performs the function of selecting a music file stored in the storage unit 130, corresponding to a ring tone required to be deleted, similar to the ring tone registration method.

The sound source unit 150 receives the call reception signal through the control unit 120. In addition, the sound source unit 150 receives a music file corresponding to a ring tone, which is read by the storage unit 130 and is selected by the user, from the control unit 120, outputs the music file as a multi-chord ring tone approximating a natural sound, and transmits the multi-chord ring tone to the reproducing unit 160. The sound source unit 150 is implemented as a sound source chip containing basic sounds therein. In this way, the contained sounds are transformed to be outputted as various sounds. At this time, the sound source chip is classified according to the transformation method. The sound source chip may be a chip using a FM, PCM, ADPCM, MIDI and a wave table. The qualities of real sounds are determined on the basis of the sound source chip. The present invention uses a sound source chip containing basic sounds capable of being outputted as multi-chord ring tones. Specifically, the present invention can employ ML series, manufactured by Oki company, and other sound source chips for supporting multi-chord ring tones. Such a sound source chip has 128 self-sound sources (original instruments) and 47 rhythm instrumental sound sources, so the sound chip can perfectly support 32-chord ring tones as well as 16-chord ring tones, and further support a user's own voice as a ring tone.

The reproducing unit 160 reproduces multi-chord ring tone output information of music files received from the sound source unit 150. The reproducing unit 160 is realized as a speaker for supporting multi-chord ring tones so as to output multi-chord ring tones. Preferably, a speaker larger than that of the conventional mobile phone is employed as the reproducing unit 160 to provide dynamic sounds.

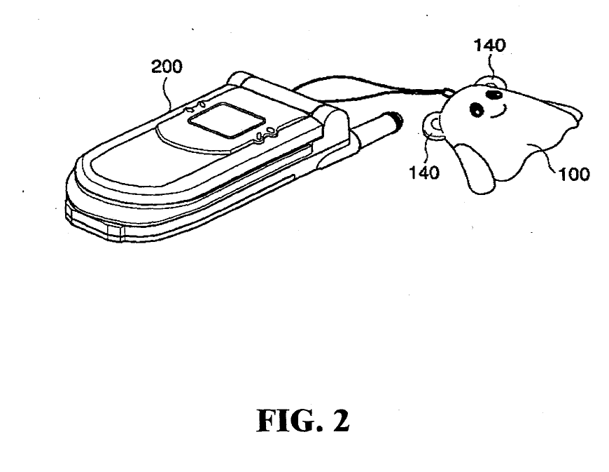

FIG. 2 is a perspective view showing an example of the connection of the mobile phone accessory for providing multi-chord ring tones to a mobile phone.

Referring to FIG. 2, it can be seen that a mobile phone accessory for providing multi-chord ring tones, indicated by reference numeral 100, is constructed in the form of a doll, and is attached to the end of a string of a mobile phone 200. Further, both ears of the doll are formed as buttons to implement the above selection unit 140.

As described above, the present invention provides a mobile phone accessory for providing multi-chord ring tones, which is attached to a conventional monotone mobile phone which does not support multi-chord ring tones or a multi-chord melody mobile phone which outputs only similar sounds simply formed by the modulation of electronic waves, and provides multi-chord ring tones of sound quality equal to a compact disc (CD) in a CD player having 128 sound source chips, thus eliminating the problem of additionally purchasing an expensive multi-chord melody mobile phone.

Further, the present invention is advantageous in that it can provide a mobile phone accessory, which provides a multi-chord ring tone supporting function together with a conventional accessory function for decoration of a mobile phone.

Further, the present invention is advantageous in that it allows a user to directly download desired ring tones from his personal computer, thus providing prompt, optional, and economical ring tone download service.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A mobile phone accessory for providing multi-chord ring tones, comprising: a reception sensor unit for sensing a reception operation generated when receiving a call in a vibration mode of the mobile phone, converting sensed information into a call reception signal, and transmitting the call reception signal to a control unit;
a control unit for reading a music file corresponding to a ring tone previously selected by a user through a selection unit from a storage unit which stores music files, and transmitting the read music file when the control unit receives the call reception signal;
a sound source unit for receiving the selected music file from the storage unit through the control unit, outputting the received music file as a multi-chord ring tone, and transmitting the multi-chord ring tone; and
a reproducing unit for reproducing multi-chord ring tone output information of the music file received from the sound source unit.

2. The mobile phone accessory according to claim 1, further comprising a connection unit for connecting a personal computer with the control unit so as to download music files stored in the personal computer to the storage unit through the control unit.

3. The mobile phone accessory according to claim 2, wherein the connection unit is a serial port cable.

4. The mobile phone accessory according to claim 1, wherein the reception sensor unit is a vibration sensor.

5. The mobile phone accessory according to claim 1, wherein the control unit is realized as a microcontroller.

6. The mobile phone accessory according to claim 1, wherein:
the selection unit is implemented as a button projected from the surface of the accessory to have a predetermined height;
the selection unit performs a selection function such that melody information selected by the pressing of a selection button is transmitted to the control unit, thus allowing a selected melody of the music files stored in the storage unit to be registered as a ring tone; and
the selection unit further performs a delete function of deleting a music file corresponding to a ring tone required to be deleted, which is stored in the storage unit, by the pressing of a button on the selection unit.

7. The mobile phone accessory according to claim 1, wherein the sound source unit is a sound source chip for supporting multi-chord ring tones.

8. The mobile phone accessory according to claim 1, wherein the reproducing unit is a speaker for supporting multi-chord ring tones.
